(19) United States
(12) Patent Application Publication
(10) Pub. No.: US 2003/0150398 A1
(43) Pub. Date: Aug. 14, 2003

(54) Pettoy

(75) Inventors: Barbara Nathanson, New York, NY (US); Jean Kersaint, New York, NY (US)

Correspondence Address: Erik J. Overberger, Esq., Fay, Sharpe, Fagan, Minnich & McKee, LLP, 7th Floor, 1100 Superior Avenue, Cleveland, OH, 44114-2518, US

(73) Assignee: Barbara Nathanson

(21) Appl. No.: 10/341,294

(22) Filed: Jan. 13, 2003

Related U.S. Application Data
(63) Continuation-in-part of application No. 09/809,132, filed on Mar. 15, 2001, now Pat. No. 6,505,576.
(60) Provisional application No. 60/189,663, filed on Mar. 15, 2000.

(51) Int. Cl. A01K 29/00

(52) U.S. Cl. 119/707

(57) ABSTRACT

A pet toy that projects a moving light beam in various directions to entertain a pet is provided. The pet toy includes a housing having an opening. A cover is connected to the housing. The cover is movable between an open position and a closed position wherein the cover substantially closes the opening. A light source is received within the housing and capable of producing a beam of light directed toward the opening. A motor is received within the housing and capable of providing a motion to the light source. A power source is within the housing for powering the light source and the electric motor. A switch is located on one of the cover and the housing. The switch has an on position allowing the power source to power the light source and the motor. The switch has an off position preventing the power source from powering the light source and the motor. The switch is generally biased toward the on position but is maintained in the off position when the cover is in the closed position.

### CROSS-REFERENCE TO RELATED APPLICATION

This application is a continuation-in-part of U.S. patent application Ser. No. 09/809,132, filed on Mar. 15, 2001, which is based on U.S. Provisional Application Serial No. 60/189,663, filed on Mar. 15, 2000, both hereby expressly incorporated by reference.

### BACKGROUND OF THE INVENTION

The present invention relates to a pet toy and, more particularly, to a new and improved automated pet toy that projects a moving light beam in various directions to entertain a pet. The present invention finds particular application as a timer-controlled, switch-activated automated moving light beam and is described herein with particular reference thereto. However, it is to be appreciated that the present invention is also amenable to other applications.

It is well known that domestic pets enjoy chasing moving objects. For example, cats are known to chase a piece of moving string and dogs are known to chase a ball. Similarly, cats and dogs are known to chase the projected red dot of a laser pointer when the red dot projected by the laser pointer is moved across a room or an area by a person. Although such an activity may entertain pets for a lengthy period of time, heretofore, a person was required to manually and continuously move the laser pointer around the room or area to keep the red dot moving.

The present invention provides a new and improved automated moving light beam for entertaining pets that only requires a person to initially actuate the device.

### BRIEF SUMMARY OF THE INVENTION

In accordance with one aspect of the present invention, a light toy is provided that projects a moving light beam in various directions for entertainment. More particularly, in accordance with this aspect of the invention, the light toy includes a housing having an opening. A cover is connected to the housing. The cover is movable between an open position and a closed position wherein the cover substantially closes the opening. A light source is received within the housing and capable of producing a beam of light directed toward the opening. A motor is received within the housing and capable of providing a motion to the light source. A power source is received within the housing for powering the light source and the electric motor. A switch is located on one of the cover and the housing. The switch has an on position allowing the power source to power the light source and the motor. The switch has an off position preventing the power source from powering the light source and the motor. The switch is generally biased toward the on position but is maintained in the off position when the cover is in the closed position.

In accordance with another aspect of the present invention, a pet toy is provided. More particularly, in accordance with this aspect of the invention, the pet toy includes a housing having an opening. A cover is connected to the housing and capable of closing the opening. The cover includes a reflective material thereon. A light source is received within the housing and capable of producing a beam of light directed through the opening and toward the reflective material. An electric motor is received within the housing and capable of providing a motion to the light source. A power source is received within the housing for powering the light source and the electric motor. A switch is located on the housing having an on position allowing the power source to power the light source and the electric motor and an off position preventing the power source from powering the light source and the electric motor.

In accordance with yet another aspect of the present invention, a pet toy is provided. More particularly, in accordance with this aspect of the invention, the pet toy includes a body and a light source for producing a light beam. The light source is contained within the body. A reflective material is connected to the body. The light beam is directed at the reflective material and the reflective material is oriented to redirect the light beam. A motor positioned within the body provides a motion to the light source thereby moving the light beam relative to the reflective portion. A switch is connected to the light source and togglable between an on position whereby the switch permits the light source to receive power and an off position whereby the switch prevents the light source from receiving power.

One advantage of the present invention resides in the provision of a pet toy that projects a moving light beam in various directions with minimal manual assistance.

Another advantage of the present invention is the provision of a pet toy that entertains pets while only requiring a human to initially actuate the device.

A further advantage of the present invention is the provision of a pet toy that automatically shuts-off to prevent drainage of a power source used to power the device.

Still another advantage of the present invention is the provision of a pet toy having a switch that activates a light source and a motor within the pet toy when a cover is open.

Still yet another advantage of the present invention is the provision of a pet toy having an indentations on an outside thereof making the pet toy easy to move and/or carry.

Another advantage of the present invention is the provision of a pet toy that has a light that randomly moves about to entertain a pet.

Yet another advantage of the present invention is the provision of a pet toy having a housing and a cover wherein the cover is selectively lockable at various angles to redirect a light beam from the housing.

Still yet another advantage of the present invention is the provision of a pet toy having a light source movable by a motor wherein delay circuitry is included to prevent premature actuation of the light source and/or the motor.

Still other advantages and benefits of the invention will be apparent to those skilled in the art upon reading and understanding the following detailed description.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 is a front elevational view of a pet toy in accordance with a first preferred embodiment of the present invention.

FIG. 2 is a rear elevational view of the pet toy of FIG. 1.

FIG. 3 is an assembly view of the pet toy of FIG. 1 showing a domed cover, a housing, and a bottom cover.

FIG. 4 is an assembly view of a light source, an electric motor, a power source, and mechanical connections therebetween received within the housing of FIG. 3.

FIG. 5 is a cross section view of a pet toy in accordance with a second preferred embodiment of the present invention.

FIG. 6 is an elevational view of a pet toy similar to the pet toy of FIG. 1 except it has an alternative finger indentation arrangement.

### DETAILED DESCRIPTION OF THE INVENTION

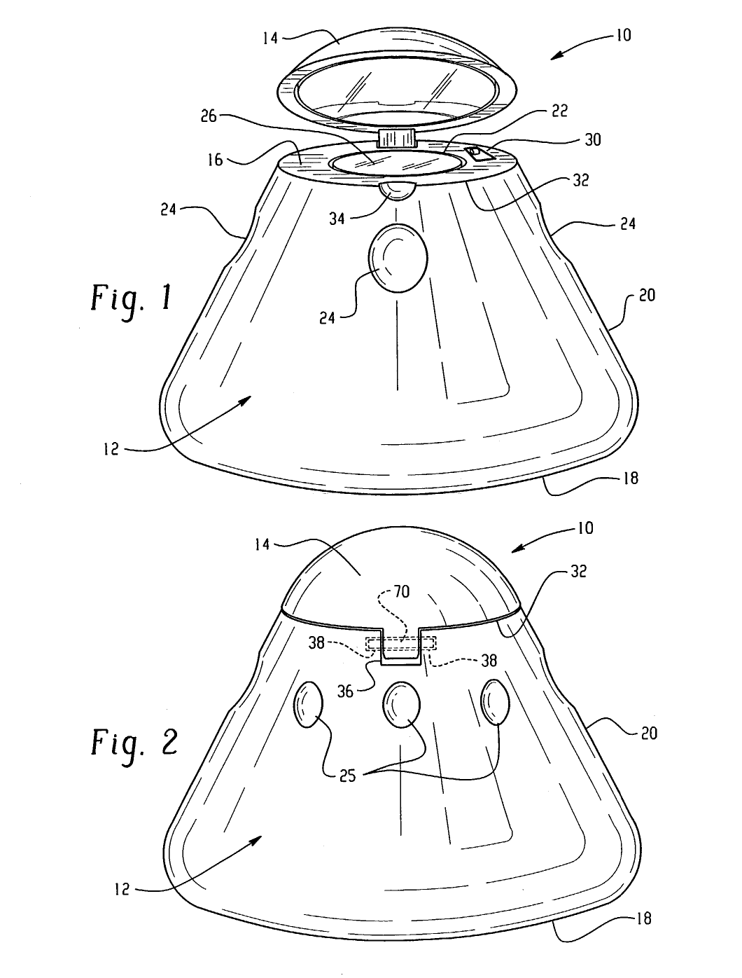

With reference to FIGS. 1 and 2, in accordance with a first preferred embodiment, a pet toy 10 includes a tapered cylindrical housing 12 and a domed cover 14. Both the housing 12 and the cover 14 are constructed of plastic in a conventional manner in the first preferred embodiment. Of course, any other suitable material and method of manufacture can be used. The generally frustoconically-shaped and hollow housing 12 includes a top wall 16, a bottom wall 18, and a body wall 20 extending therebetween.

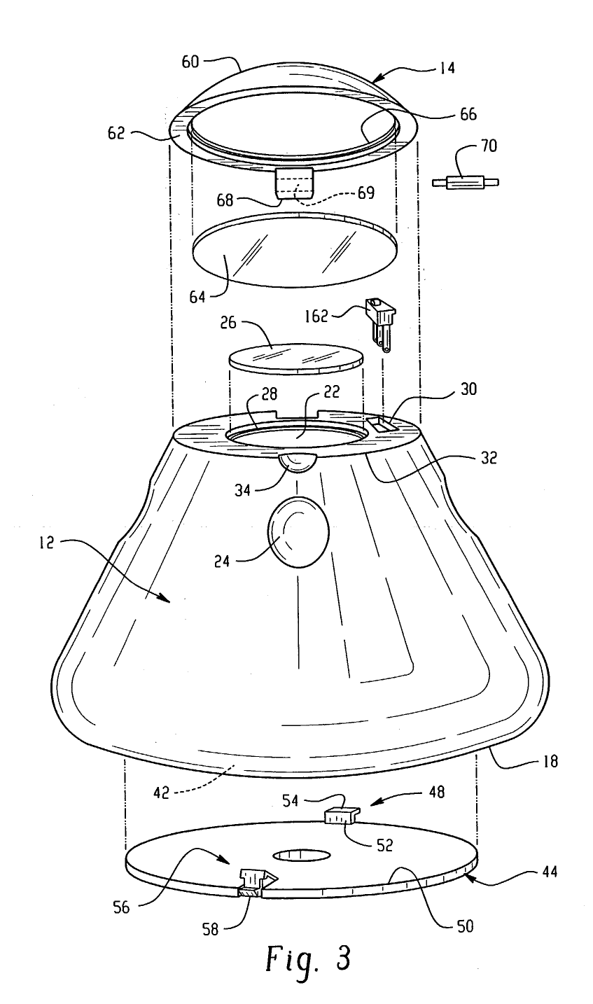

The top wall 16 includes a counterbored circular opening 22 that leads into a cavity located inside the housing 12 and defined by the walls 16, 18, 20 of the housing 12. A round instrument glass piece 26 is positioned snugly on the counterbored edge 28 (FIG. 3) of the counterbored opening 22. A plurality of thumb indentations 24 (FIG. 1) and finger indentations 25 (FIG. 2) are positioned on the body wall 20 for ease of carrying the pet toy 10. Additionally, the top wall 16 includes a switch opening 30.

A peripheral edge 32 is defined by the intersection of the top wall 16 and the body wall 20. A concave thumb notch 34 is cut into the top wall 16 and the body wall 20 along the peripheral edge 32 at a front portion thereof. A connector notch 36 is cut into the top wall 16 and the body wall 20 along the peripheral edge 32 at a rear portion thereof and opposite the thumb notch 34. On both sides of the connector recess 36, a pair of opposing pin recesses 38 are disposed.

With additional reference to FIG. 3, the bottom wall 18 includes a counterbored bottom opening 42 that connects to the cavity of the housing 12. A base cover 44 fits snugly within a counterbored edge (not shown) of the bottom opening 42. The bottom cover 44 includes a latch 48 disposed near a peripheral edge 50 of the base cover 44. The latch 48 is L-shaped having a bottom latch portion 52 extending upwardly from the base cover 44 and upper latch portion 54 normal to the bottom latch portion 52 and extending radially outwardly from the bottom latch portion 52. A spring lock 56 is disposed along the peripheral edge 50 of the base cover 44 and is positioned opposite the latch 48. The spring lock 56 includes a detent 58 that is selectively movable between a resting position wherein the detent 58 protrudes radially outwardly relative to the peripheral edge 50 of the base cover 44 and a compressed position wherein the detent 58 does not protrude beyond the peripheral edge 50 of the base cover 44. Together, the latch 48 and the spring lock 56 allow the base cover 44 to be removably secured to the bottom wall 18 of the housing 12 closing the bottom opening 42. The bottom wall 18 can also include one or more rubber pads (not shown) on an underside thereof. The rubber pads can prevent the toy 10 from skidding.

Alternatively, the bottom wall 18 may include only a battery compartment cover appropriately sized to correspond to one or more batteries held within the housing 12. The battery compartment cover can slide or pivot open to allow for replacement of the one ore more batteries used to power the toy 10 such as found on conventional battery powered devices. In this arrangement, there would not be a need for the base cover 44. Of course, other arrangements are possible and all such arrangements are to be considered within the scope of the present invention.

The domed cover 14 includes a rounded top side 60 and a substantially flat underside 62. A rounded or disc-shaped mirror 64 is received in a counterbored opening 66 located on the flat underside 62 of the domed cover 14. The domed cover 14 connects to the cylindrical housing 12 by a hinged connection including a tab member 68 having a throughhole 69, the pin recesses 38 (FIG. 2) and a pin 70. More specifically, the tab member 68 depends from the cover 14 at or near a peripheral edge of the cover 14 and is received in the connector recess 36. The pin 70 is positioned within the throughhole 69 and its ends engage the pin recesses 38 of the housing 12 to pivotally secure the domed cover 14 to the housing 12. The hinged connection between the cover 14 and the housing 12 can include a sufficient amount of frictional resistance that allows the cover 14 to be opened to and held in any desired position.

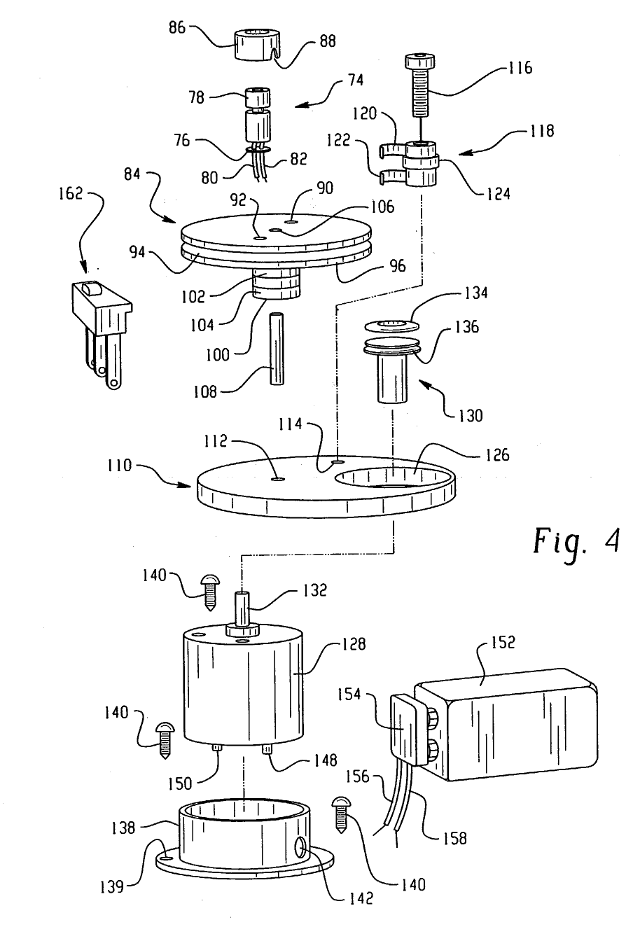

With additional reference to FIG. 4, a light source 74 is received within the cavity of the housing 12. In the preferred embodiment, the light source 74 is an LED light. However, the light source 74 may be any other suitable lighting such as a laser light or the like. The light source 74 includes a regulating circuit board 76 for creating a light beam directed toward the opening 22, an adjustable top 78 for adjusting the width of the light beam, and a pair of leads 80,82 for powering the light source 74.

The light source 74 is supported on a rotating disc platform 84 and surrounded by a cylindrical support collar 86. The leads 80,82 pass through a port 88 located in a side of the supporting collar 86 and connect to terminals 90,92 on a top side of the rotating disc platform 84. The rotating disc platform 84 includes a groove 94 along a radial edge 96 thereon for receiving a rubber ring (not shown). On an underside of the rotating disc platform 84, a cylindrical extension member 100 extends downward and holds a pair of lead contact rings 102,104 annularly thereon. The lead contact rings 102,104 are respectively electrically connected to the terminals 90,92.

A hole 106 extends through an axial center of the rotating disc platform 84 from the top side to the underside and through the extension member 100. The hole 106 receives a pin member 108 for rotatably connecting the rotating disc platform 84 to a base plate 110. A pin recess 112 is disposed on an upper surface of the base plate 110 for receiving one end of the pin member 108.

The base plate 110 also includes a terminal recess 114 on the upper face thereof. A bolt screw 116 connects a contact terminal 118 to the base plate 110 by screwing into the terminal recess 114. The contact terminal 118 includes positive and negative leads 120,122 separated by an insulator 124. The position of the terminal recess 114 relative to the pin recess 112 allows for contact between the terminal leads 120,122 and corresponding lead contact rings 102,104 of the rotating disc platform 84 while causing minimal frictional drag on the extended member 100 of the rotating disc platform 84.

The base plate 110 includes a mounting hole 126 for securing the disc platform 84 to an electric motor 128. A pulley member 130 fastens securely onto a shaft 132 of the motor 128 and securely carries a friction ring 134 in a channel 136 thereon. The pin recess 112 is positioned relative to the mounting hole 126 such that the friction ring 134 is in frictional engagement with the rubber ring of the rotating disc platform 84. Thus, if the pulley member 130 and its frictional ring 134 rotate, the frictional contact between the friction ring 134 and the rubber ring will cause the rotating disc platform 84 to rotate.

The electric motor 128 is secured in place by a supporting collar 138. The supporting collar 138 includes mounting holes 139 for securing the collar 138 to the housing 12 via screws 140. The supporting collar 138 includes a connector port 142 through which a pair of motor leads (not shown) connected to motor terminals 148,150 pass. When the electric motor 128 is powered, the motor shaft 132 will rotate and, in turn, the pulley member 130 will rotate and cause rotation of the rotating disc platform 84 as described above.

Power for the motor 128 and the light source 74 derives from a conventional battery 152. Of course, other power sources could be used such as conventional AC power, other battery arrangements or the like. The battery 152 is removably secured within a portion of the cavity by means of a conventional battery mounting bracket (not shown). The battery 152 is accessible, for replacement, by removing the base cover 44 from the housing 12. A battery terminal connector 154 connects a pair of battery leads 156,158 to the battery 152. The leads 156,158 connect to a printed circuit board (not shown). The circuit board distributes power to the light source 74 and the motor 128 as will be described in more detail below.

With reference to FIG. 3, a switch 162 is securely mounted within the switch opening 30 such that the switch 162 protrudes from top wall 16. The switch 162 is electrically connected between one of the battery leads 156,158 of the battery 152 (FIG. 4) and the printed circuit board. The switch 162 toggles or is movable between depressed off position where power is prevented from passing from the battery 152 to the circuit board and a released on position where power is allowed to pass from the battery to the circuit board. The switch 162 is generally bias toward the released on position and is movable to and held in its depressed off position when the cover 14 substantially closes the opening 22 of the housing 12, i.e., the underside 62 of the cover 14 mates with or rests against the top wall 16 of the housing 12 and thereby depresses the switch 162 which extends slightly above the top wall 16 when the switch is in the extended open position.

The circuit board includes a fixed voltage regulator chip for reducing the voltage produced by the battery 152 to a suitable voltage for either or both the light source 74 and the motor 128 when necessary. The circuit board also includes a timer circuit having a timer chip, a resistor, and an electrolytic capacitor. The timer chip is in electrical communication with the leads 120,122 of the contact terminal 118, thus, providing power to the light source 74.

The circuit board further includes a magnetic reed relay energized by the timer chip for supplying power to an oscillator chip provided on the circuit board. The oscillator chip is connected to a resistor and capacitor for determining a frequency thereof. The oscillator chip drives a miniature relay on the circuit board that is electrically connected to the motor terminals 148,150 for supplying current pulses to the electric motor 128 to selectively power the motor 128. As already discussed, the position of the light source 74 is rotated when the motor 128 is powered. All of the inputs of the relays on the circuit board are filtered by a pair of miniature capacitors and a switching diode combination to absorb any voltage spikes generated by collapsing magnetic fields of coils in the relays.

To operate the pet toy 10, a user opens the domed cover 14 to a desired reflecting position wherein the mirror 64 is positioned over the opening 22 and the switch 162 is allowed to move to the on position. The cover 14 remains in the desired reflecting position as a result of the frictional resistance of the hinged connection between the cover 14 and the housing 12. As already discussed, the switch 162 is normally bias toward the on position. However, when the domed cover 14 is closed against the housing 12, the domed cover 14 acts on the switch 162 and causes or urges the switch 162 to move to and remain in the off position. When the domed cover 14 is open, the switch 162 is free to move toward the on position.

With the switch 162 in the on position, power from the battery 152 flows to the circuit board. More specifically, power or electricity flows through the voltage regulator and to the timer circuit. The timer circuit permits voltage to flow continuously therethrough for a predefined period of time, such as fifteen minutes. Of course, the predefined period of time may vary depending upon the precise components of the timer circuit and arrangement thereof. If the switch 162 remains in the on position for the predefined period of time, the timer circuit acts to disrupt the flow of electricity to the light source 74 and the electric motor 128. The timer circuit will not allow electricity to again pass to the light source 74 and the motor 128 until the switch 162 is re-set, i.e., at least temporarily moved to the off position. Moving the switch 162 to the off position may be accomplished manually or by closing the domed cover 14. In the off position, the switch 162 prevents electricity from flowing to the circuit board and, specifically, the timer circuit thereby allowing the timer circuit to reset for the next time the switch 162 is moved to the on position.

When the switch 162 is in the on position and the timer circuit allows electricity to pass therethrough, i.e., the switch 162 has not been in the on position for the predetermined amount of time, the light source 74 is actuated and produces a beam of light directed at the mirror 64 on the underside of the cover 14. The mirror 64 redirects the light beam radially outward from the pet toy 10. Further, current pulses are generated and sent to the electric motor 128 via the oscillator chip and associated relays to intermittently drive the motor 128 thereby rotatably moving the light source 74. In a preferred form, the motor 128 rotates the light source 74 and, at random intervals, the motor 128 stops and pauses before resuming rotation of the light source 74. In this manner, the light beam generated by the light source 74 and redirected by the mirror 64 rotates in a radially outward direction from the pet toy 10 while periodically making random stops. Thus, a pet is entertained by the rotating light beam generated by the pet toy 10 that varies its pattern of rotating and stopping. Optionally, the motor 128 could be configured to selectively operate at one of a plurality of varying speeds. To select a speed, a speed selection switch could be positioned on the bottom wall 18 wherein the switch would be movable to a position representative of one of the varying speeds. A user could then vary the speed of the motor 128 by moving the switch to another position.

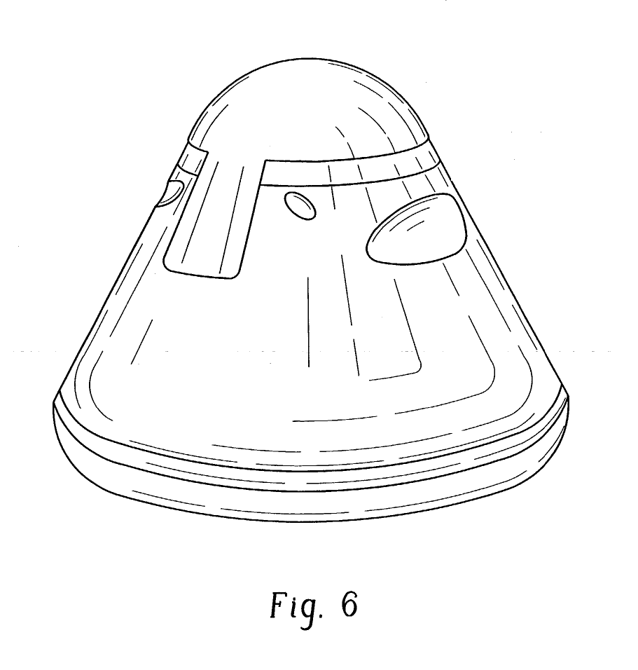

Alternatively, the pet toy 10 can be used as a manually operated device. In this case, to operate the pet toy 10, a user opens the domed cover 14 to a fully open position wherein the mirror 64 is no longer positioned over the opening 22 and, thus, the light beam is not obstructed or redirected by the mirror 64. Unlike conventional laser pointers and the like, the light beam produced by the light source 74 of the pet toy 10 will generally remain on when the cover 14 is open and does not require the user to hold down a power button to keep the light beam on. If the optional speed selection switch is provided on the toy 10, it can include an off position whereby the motor 128 does not move the light source 74. In this mode, a user can manually move the toy 10 about to direct the light beam and entertain a pet. The pet toy 10 can be appropriately sized to make holding and maneuvering the toy 10 relatively easy. Additionally, with reference to FIG. 6, the pet toy 10 can include alternative finger indentations, as shown, to further make holding and maneuvering the toy 10 relatively easy.

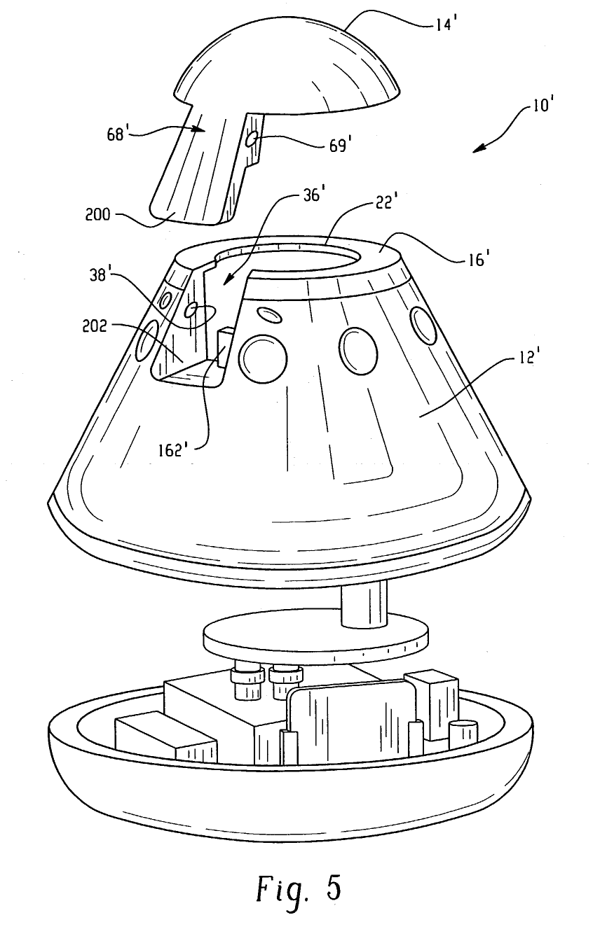

With reference to FIG. 5, a pet toy 10′ is shown according to a second preferred embodiment of the present invention. In most respects, the pet toy 10′ is like the pet toy 10 of the first preferred embodiment and like reference numerals are used with a prime (′) suffix to represent like elements. However, the location and operation of the switch that controls the flow of power from the battery to the circuit board is different in the pet toy 10′ and new components of the pet toy 10′ are used with new numerals. More specifically, the pet toy 10′ includes a cover 14′ hingedly connected to a housing 12′. The cover 14′ includes a tab member 68′ having a throughhole 69′. The tab member 68′ is received within a connector recess 36′ of the housing. A pin (not shown) passes through the throughhole 69′ and its ends are received within pin recesses 38′ on the housing 12′ thereby pivotally securing the cover 14′ to the housing 12′.

An extension member 200 depends downwardly from a distal end of the tab member 68′. The extension member 200 is received in a lower portion 202 of the connection recess 36′. A switch 162′ is positioned in the lower portion 202. Like the first preferred embodiment, the switch 162′ is bias toward a released, on position where the switch 162′ allows power to flow from a power source (not shown) to a circuit board (not shown). When the cover 14′ is substantially closed or closing an opening 22′, the extension member 200′ is positioned such that it moves or urges the switch 162′ to a closed, off position. In all other aspects, the function of the switch 162′ is like that of the switch 162 of the first preferred embodiment. With the new position of the switch 162′, no switch recess is necessary on the top wall 16′ of the housing 12′. Rather, a switch recess is located in the lower portion 202 and receives the switch 162′.

In either the first or second preferred embodiments, the domed cover 14 can optionally include a locking pivotal connector (not shown) that secures the domed cover 14 to the housing 12. The locking pivotal connector replaces the pin 70 and pin receptor 68 connection. The locking pivotal connector is configured to allow the domed cover 14 to remain open at various angles or degrees without human assistance. The locking pivotal connector permits the pet toy 10 to project the light beam at various angles depending upon user preference. For example, the locking pivotal connector may be used to only allow the domed cover 14 to remain open at a fixed number of predefined angles. The predefined angles may be designed to direct the light beam specific distances along a floor and/or at a wall surface. Additionally, a controller operatively connected to the locking pivotal connector may be integrated into the circuit board that only allows the light source 74 to function when the domed cover 14 is secured at these predefined angles. A delay circuit may also be included on the circuit board for purposes of providing a user sufficient time to set the angle of the domed cover 14 and place the pet toy 10 in a desired location before allowing actuation of the light source 74.

The invention has been described with reference to the preferred embodiments. Obviously, modifications and alterations will occur to others upon reading and understanding the preceding detailed description. It is intended that the invention be construed as including all such modifications and alterations insofar as they are within the scope of the appended claims or the equivalents thereof.

Having thus described the preferred embodiments, the invention is now claimed to be:

1. A pet toy comprising:
a housing having an opening;
a cover connected to the housing, the cover movable between an open position and a closed position wherein the cover substantially closes the opening;
a light source received within the housing and capable of producing a beam of light directed toward the opening;
a motor received within the housing and capable of providing a motion to the light source;
a power source within the housing for powering the light source and the electric motor; and
a switch located on one of the cover and the housing, the switch having an on position allowing the power source to power the light source and the motor and an off position preventing the power source from powering the light source and the motor, the switch generally biased toward the on position but maintained in the off position when the cover is in the closed position.

2. The pet toy of claim 1 wherein one of the cover and the housing includes a reflective material capable of redirecting the beam of light produced by the light source.

3. The pet toy of claim 1 wherein a transparent piece is mounted on the housing over the opening and a reflective material is mounted on an underside of the cover capable of reflecting the beam of light produced by the light source.

4. The pet toy of claim 1 further including a power source.

5. The pet toy of claim 1 wherein the housing further includes a plurality of grip indentations on an outside portion of the housing.

6. The pet toy of claim 1 wherein the switch is located on an upper wall of the housing.

7. The pet toy of claim 1 wherein the switch is located adjacent an intersection between a top wall of the housing and a body wall of the housing.

8. The pet toy of claim 7 wherein the switch is positioned on the housing and an extension member of the cover adjacent a hinged connection between the cover and the housing moves the switch to the closed position when the cover is in the closed position.

9. The pet toy of claim 1 wherein a timer is received within the housing and operatively connected to the power source and at least one of the electric motor and the light source for limiting continuous power thereto, the timer terminating power to the at least one of the electric motor and the light source if power flows continuously thereto for a predetermined period of time.

10. The pet toy of claim 1 wherein an oscillator chip is received within the housing and operatively connected to the electric motor for stopping and starting rotation of the light source at random intervals thereby varying the pattern of motion of the light source.

11. The pet toy of claim 1 wherein the light source comprises an LED light.

12. The pet toy of claim 1 wherein the light source comprises a laser light.

13. The pet toy of claim 1 wherein the cover is pivotally attached to the housing and includes locking angles which allow the cover to remain opened at predetermined angles.

14. The pet toy of claim 1 wherein the light source includes a delay preventing activation of the light source for a predefined period of time.

15. A pet toy comprising:
a housing having an opening;
a cover connected to the housing and capable of closing the opening, the cover including a reflective material thereon;
a light source received within the housing and capable of producing a beam of light directed through the opening and toward the reflective material;
an electric motor received within the housing and capable of providing a motion to the light source;
a power source received within the housing for powering the light source and the electric motor; and
a switch located on the housing having an on position allowing the power source to power the light source and the electric motor and an off position preventing the power source from powering the light source and the electric motor.

16. The pet toy of claim 15 wherein the switch is biased toward the on position but maintained in the off position when the cover is closing the opening.

17. A pet toy comprising:
a body;
a light source for producing a light beam, the light source contained within the body;
a reflective material connected to the body, the light beam directed at the reflective material and the reflective material oriented to redirect the light beam;
a motor positioned within the body provides a motion to the light source thereby moving the light beam relative to the reflective portion; and
a switch connected to the light source and togglable between an on position whereby the switch permits the light source to receive power and an off position whereby the switch prevents the light source from receiving power.

18. The pet toy of claim 17 further including:
a cover attached to the body, the cover including the reflective material thereon and the cover capable of closing to substantially prevent light from passing from the body.

19. The pet toy of claim 18 wherein the switch is generally urged toward the on position but is maintained in the off position when the cover is closed.
